(19) United States
(12) Patent Application Publication
(10) Pub. No.: US 2010/0083642 A1
(43) Pub. Date: Apr. 8, 2010

(54) Exhaust gas purification device, manufacturing method thereof, and manufacturing device thereof

(75) Inventors: Sung Mu Choi, Seongnam-city (KR); Jung Min Seo, Suwon-city (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/512,762

(22) Filed: Jul. 30, 2009

(30) Foreign Application Priority Data
Oct. 2, 2008 (KR) 10-2008-0097219
Nov. 14, 2008 (KR) 10-2008-0113491

(51) Int. Cl. F01N 3/035; F01N 3/02; F01N 7/00; B21D 51/16; B23P 19/02

(52) U.S. Cl. 60/297; 60/311; 60/324; 29/890.08; 29/525

(57) ABSTRACT

The present invention relates to an exhaust gas purification apparatus of a vehicle, a manufacturing method thereof, and a manufacturing device thereof. The exhaust gas purification apparatus that includes a filter in which a plurality of channels are formed therein such that exhaust gas exhausted from a combustion chamber can pass therethrough to trap pollutants included in the exhaust gas, may include a first plug that plugs an inlet of at least one channel, and a second plug that plugs an outlet of at least one channel, wherein the first plug is inserted in a predetermined distance from the inlet of the at least one channel toward an outlet direction thereof at a front surface of the at least one channel.

### CROSS-REFERENCE TO RELATED APPLICATION

The present application claims priority to Korean Patent Application No. 10-2008-0097219 filed on Oct. 2, 2008 and Korean Patent Application No. 10-2008-0113491 filed on Nov. 14, 2008, the entire contents of which are incorporated herein for all purposes by this reference.

### BACKGROUND OF THE INVENTION

1. Field of the Invention

The present invention relates to an exhaust gas purification apparatus of a vehicle, a manufacturing method thereof, and a manufacturing device thereof, and more particularly to an exhaust gas purification apparatus in which the regeneration efficiency thereof is improved when it is regenerated at a predetermined temperature such that a clogging phenomenon is decreased, a manufacturing method thereof, and a manufacturing device thereof.

2. Description of the Related Art

In a catalytic filter of an exhaust gas purification apparatus, a plurality of channels are formed in the flow direction of exhaust gas, and particulate matter (PM) are trapped while passing through the channels.

Generally, an inlet of at least one among the channels is closed and an outlet thereof is opened, an inlet of at least one other among the channels is closed and an outlet thereof is opened, and the closed portions are alternatively disposed.

Meanwhile, a catalyzed particulate filter (CPF) among catalyst apparatuses is applied to accumulate and eliminate particulate matter (PM).

Recently, a compound type of CPF, in which the functions of a diesel oxidation catalyst (DOC) and a diesel oxidation catalyst (DPF) are jointly applied, has bee used so as to satisfy regulations for exhaust gas.

FIG. 6 is a cross-sectional side view of a filter that is provided in a general exhaust gas purification apparatus.

As shown, a first wall, a second wall, and a third wall 10 are formed in a filter, channels 19 and 18 are formed therebetween, a first plug 16 is disposed in the inlet side of one channel 19, and a second plug 14 is disposed in the outlet of the other channel 18.

As the exhaust gas passes the filter, the particulate matter is attached on the front surface and the inside surface of the front end part thereof, and a deposit 12 of the particulate matter that is attached grows at the inlet side such that the inlet of the second channel 18 can be clogged.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an exhaust gas purification apparatus having advantages of reducing clogging of a filter, a manufacturing method thereof, and a manufacturing device thereof.

In an aspect of the present invention, the exhaust gas purification apparatus that includes a filter in which a plurality of channels are formed therein such that exhaust gas exhausted from a combustion chamber can pass therethrough to trap pollutants included in the exhaust gas, may have a first plug that plugs an inlet of at least one channel, and a second plug that plugs an outlet of at least one channel, wherein the first plug is inserted in a predetermined distance from the inlet of the at least one channel toward an outlet direction thereof at a front surface of the at least one channel.

The filter may be applied to a diesel particulate filter (DPF).

The at least one channel including the first plug and the at least one channel including the second plug may be alternatively disposed.

The filter may be applied to a catalyzed particulate filter (CPF) in which an oxidation catalyst or a wash coat is coated therein.

The filter may be mounted in a diesel oxidation catalyst (DOC) or a diesel particulate filter (DPF), wherein a selective catalytic reduction apparatus is mounted at a downstream side of the filter.

A temperature of the filter may be increased toward a rear end portion from a frond end portion of the filter in a regeneration mode for eliminating trapped soot in the filter, and the first plug may be disposed at a position having a predetermined temperature such that the trapped soot can be eliminated, wherein the predetermined distance of the first plug is more than approximately one inch.

The filter may be extended as much as the predetermined distance of the first plug.

In another aspect of the present invention, a method for forming a plug that alternatively closes an inlet or outlet of channels that are formed in a flowing direction of exhaust gas, may include a first injection step of injecting a plugging material into the channels of a filter body so as to form the plug closing the inlet or outlet of the channels, a second injection step of moving the plug toward an outlet direction of the channels with at least a predetermined length by injecting a high polymer organic compound into the channel, and a removing step of removing the injected high polymer organic compound except the plug.

In further another aspect of the present invention, the method for forming a plug may further include facing one side surface of a mask toward a front surface of the filter body wherein the mask includes a mask hole formed corresponding to the channels, facing a pushing member against the mask with a predetermined gap, disposing a plugging material between the pushing member and the mask, and actuating a driving portion to push the pushing member toward the mask such that the plugging material is injected into the channels through the mask holes.

The method for forming a plug may further include facing one side surface of a mask toward a front surface of the filter body wherein the mask includes a mask hole formed corresponding to the channels, facing a pushing member against the mask with a predetermined gap, actuating a driving portion to insert the pushing member into inlets of the channels with a predetermined amount, disposing a high polymer organic compound between the pushing member and the mask, and actuating the driving portion to push the pushing member toward the mask such that the high polymer organic compound is injected into the channels through the mask holes so as to move the plugging material forwards as much as a predetermined length.

In the removing step of the high polymer organic compound, the high polymer organic compound may be removed at a higher temperature than a predetermined temperature.

In further another aspect of the present invention, the device for manufacturing an exhaust gas purification device for forming a plug in a filter body in which a plurality of channels are formed in a flowing direction of exhaust gas, may include a mask of which one side surface thereof faces a front surface of the filter body wherein the mask includes a mask hole formed corresponding to the channels, a pushing member that faces the mask with a predetermined gap, a plugging material that is disposed between the pushing member and the mask, and a driving portion that moves the pushing member toward the mask so as to inject the plugging material into the channels through the mask holes with a predetermined amount, wherein a high polymer organic compound is injected into the channels through the mask holes so as to push the inserted plugging material by as much as a predetermined distance, and the injected high polymer organic compound is removed except the plugging material.

The device for manufacturing an exhaust gas purification device may further include a heating unit that removes the high polymer organic compound with heat from the channels.

In various aspects of the present invention, in the exhaust gas purification device the plug may be inserted toward the outlet of the filter body at a predetermined depth such that a front open area thereof is not blocked. Further, the elimination efficiency of the particulate material is improved such that the plugging phenomenon thereof is prevented and back pressure is reduced to improve output of the engine.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic side view of an exhaust gas purification apparatus according to an exemplary embodiment of the present invention.

FIG. 2 shows a temperature distribution and a side view of an exhaust gas purification apparatus according to an exemplary embodiment of the present invention.

FIG. 3 is a cross-sectional side view of a filter that is provided in an exhaust gas purification apparatus according to an exemplary embodiment of the present invention.

FIG. 4 is a table showing temperature when a filter that is provided in an exhaust gas purification apparatus according to an exemplary embodiment of the present invention is regenerated.

FIG. 5A to FIG. 5G are cross-sectional side views showing a sequential manufacturing method of an exhaust gas purification device according to an exemplary embodiment of the present invention.

FIG. 6 is a cross-sectional side view of a filter that is provided in a general exhaust gas purification apparatus.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

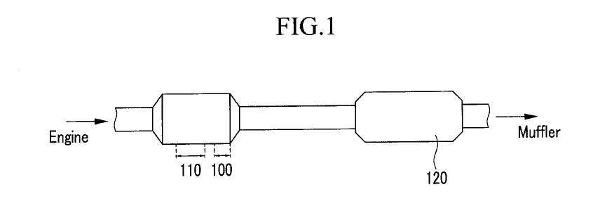

FIG. 1 is a schematic side view of an exhaust gas purification apparatus according to an exemplary embodiment of the present invention.

As shown, a diesel particulate filter 110 and a diesel oxidation catalyst 100 are sequentially disposed on the exhaust pipe, and a selective catalyst reduction device (SCR) 120 is disposed at the rear thereof.

In the present exemplary embodiment, an oxidation catalyst or a wash coat material can be coated in the diesel particulate filter (DPF) 110 to have the same function as that of a catalyzed particulate filter (CPF).

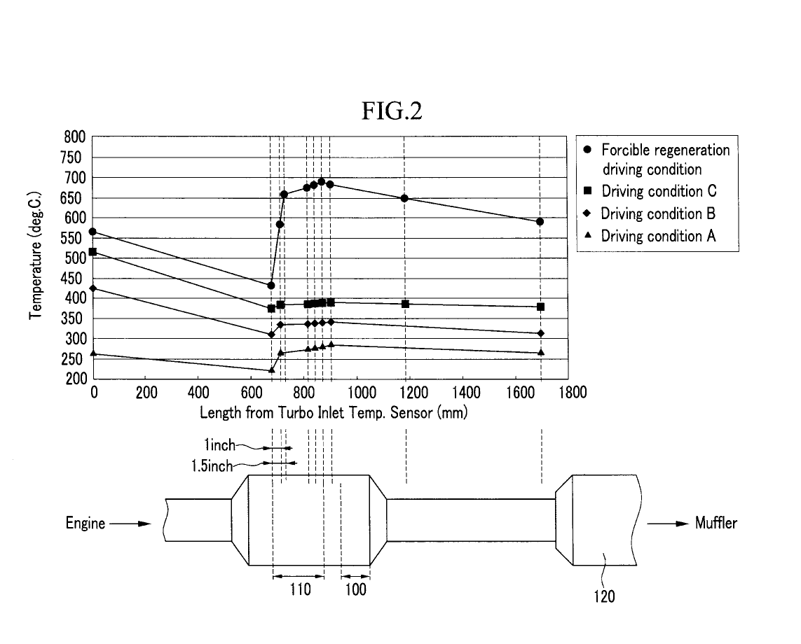

FIG. 2 shows a temperature distribution and a side view of an exhaust gas purification apparatus according to an exemplary embodiment of the present invention.

The temperature of the catalyzed particulate filter 115 is raised to a predetermined temperature so as to bum and eliminate particulate matter that is trapped in the catalyzed particulate filter 115.

Referring to FIG. 2, the temperature of the front end part of the filter 115 is lower than 250 degrees Celsius in a driving condition A, and the temperature rises and drops toward the rear side thereof. Likewise, in driving conditions B and C, the temperature of the front end part of the filter 115 is lower than 400 degrees Celsius, and the temperature rises and drops toward the rear side thereof.

Fuel is additionally injected in the compulsory regeneration driving condition so as to raise the temperature of the catalyzed particulate filter 115 to higher than 600 degrees Celsius, and therefore the temperature of the front end part of the catalyzed particulate filter 115 is about 450 degrees Celsius, the temperature at a 1 inch position is about 600 degrees Celsius, and the temperature at a 1.5 inch position is about 650 degrees Celsius.

The particulate matter that is trapped in the diesel particulate filter 110 efficiently burns to be eliminated at a high temperature (about 600 degrees Celsius), but owing to the temperature distribution as stated above, the particulate matter that is trapped at the front end surface of the filter 110 does not effectively bum to be eliminated.

However, the structure of the diesel particulate filter 110 is improved to enhance the regeneration efficiency thereof in an exemplary embodiment of the present invention.

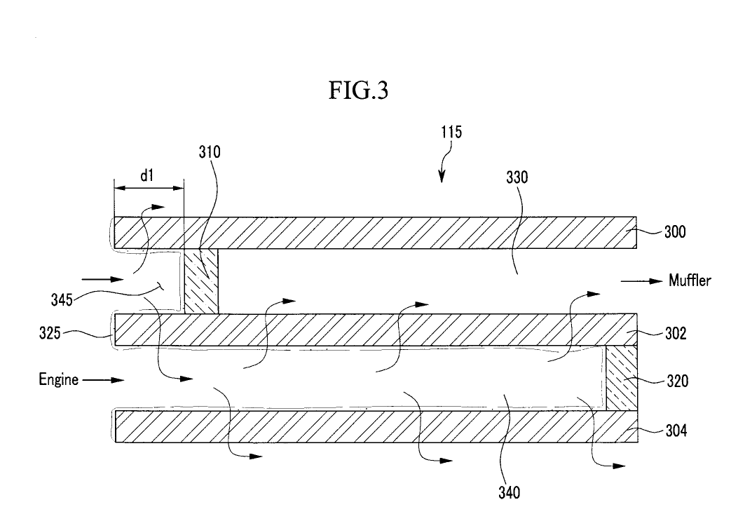

The detailed structure of the diesel particulate filter 110 is specifically described referring to FIG. 3.

FIG. 3 is a cross-sectional side view of a filter that is provided in an exhaust gas purification apparatus according to an exemplary embodiment of the present invention.

Referring to FIG. 3, a first wall 300, a second wall 302, and a third wall 304 are disposed to form at least a first channel 330 and a second channel 340 in the diesel particulate filter 110, and the exhaust gas flows through the second channel 340 from the opened inlet (left) to the rear (right).

Further, the inlet of the first channel 330 is closed by a first plug 310, and the outlet of the second channel 340 is closed by a second plug 320. Accordingly, the exhaust gas flows into the inlet of the second channel 340, and penetrates the second wall 302 to flow to the opened outlet of the first channel 330.

The first plug 310 that is provided in the diesel particulate filter 110 is inserted by a first distance d1 at the front surface of the inlet. Further, it is desirable that the length of the diesel particulate filter 110 is extended by the first length d1 in an exemplary embodiment of the present invention.

Since the first plug 310 is inserted in a length direction of the first channel 330 as described above, a groove 345 is formed in the first channel front end portion in which the first plug 310 is disposed, and particulate matter 325 is trapped inside the groove 345.

Because the particulate matter 325 is trapped inside the groove 345, it can be resolved that a buildup of the trapped particulate matter grows toward the inlet side of the second channel 340. Here, although the particulate matter is trapped inside the groove, it burns to be eliminated in the above regeneration mode.

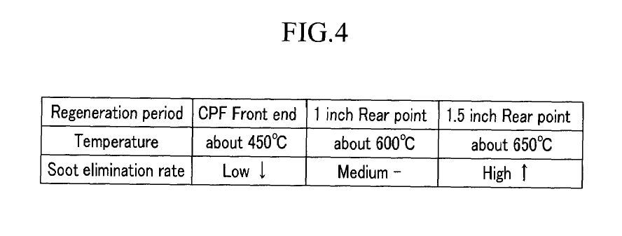

FIG. 4 is a table showing a temperature when a filter that is provided in an exhaust gas purification apparatus according to an exemplary embodiment of the present invention is regenerated.

Referring to FIG. 4, the front end part temperature of the diesel particulate filter 110 is about 450 degrees Celsius, the 1 inch latter part thereof is about 600 degrees Celsius, and the 1.5 inch latter part thereof is about 650 degrees Celsius, so the elimination efficiency of the trapped soot is low at the front end part and is high at the 1.5 inch latter part.

Accordingly, it can be resolved that the frontal open area is reduced by inserting the first plug 310 by the 1.5 inch length as stated above.

A catalyst metal may be coated by wash-coating the inside of the filter 110 so as to effectively regenerate the filter 115, and the coated catalyst metal effectively eliminates the trapped soot and particulate matter in the regeneration mode in which the temperature of the filter 110 is raised.

In an exemplary embodiment of the present invention, the sectional shape of the channel of the filter can be one of several kinds, such as a square, a hexagon, a circle, a triangle, and so on.

Further, it is only one example that the channel of the catalyzed particulate filter is formed by the first wall 300, the second wall 302, and the third wall 304 in an exemplary embodiment of the present invention, and it can be changed to be embodied in a variety of different forms.

One channel of the diesel particulate filter (DPF) according to an exemplary embodiment of the present invention is opened in one direction, and the other channel thereof is opened in the opposite direction.

Also, the inlets and the outlets of the channels are alternatively closed by the plugs, the entire section of the channels has a check pattern, and the exhaust gas can penetrate the cell walls.

As described above, the particulate matter (PM) is trapped on/in the cell walls inside the channels, a part of the harmful exhaust gas is oxidized or reduced by the catalyst that is coated on the cell walls inside thereof to be transformed to harmless materials, and the other gas is exhausted to the rear side thereof.

However, as the amount of trapped particulate matter increases, exhaust gas resistance is also increased. So as to reduce the above problem, the materials trapped inside the channel are burned to be eliminated at a predetermined high temperature.

As described above, there are many kinds of honeycomb types of sectional shapes of the channels of the catalyzed particulate filter, and it can be transformed corresponding to design specifications.

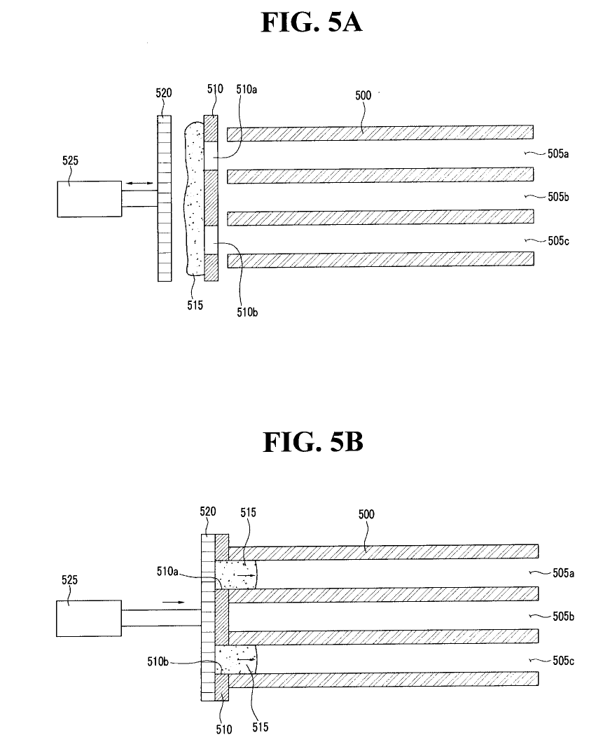

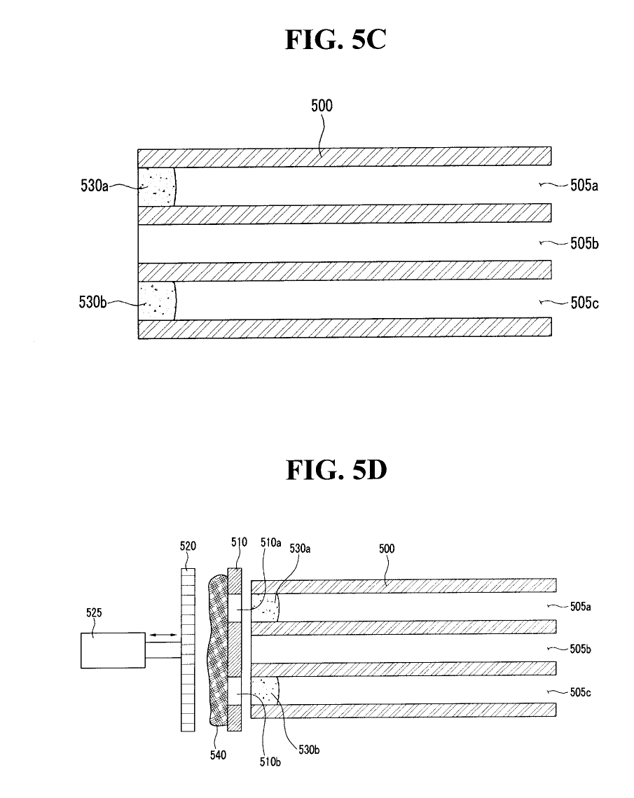

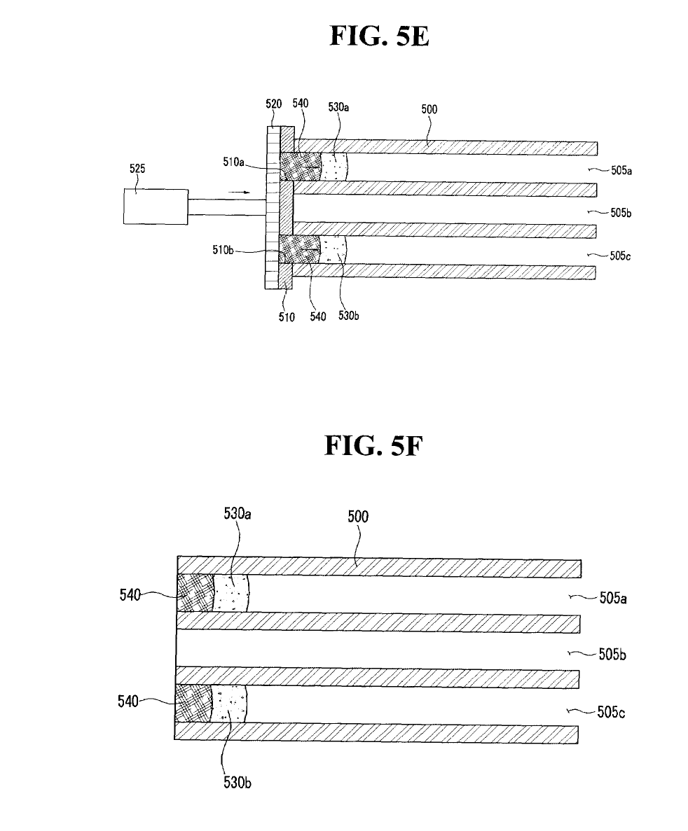

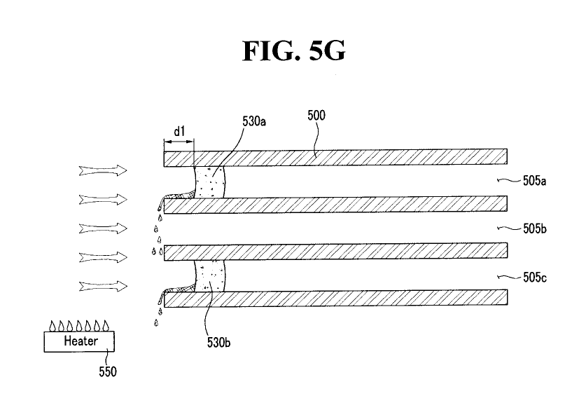

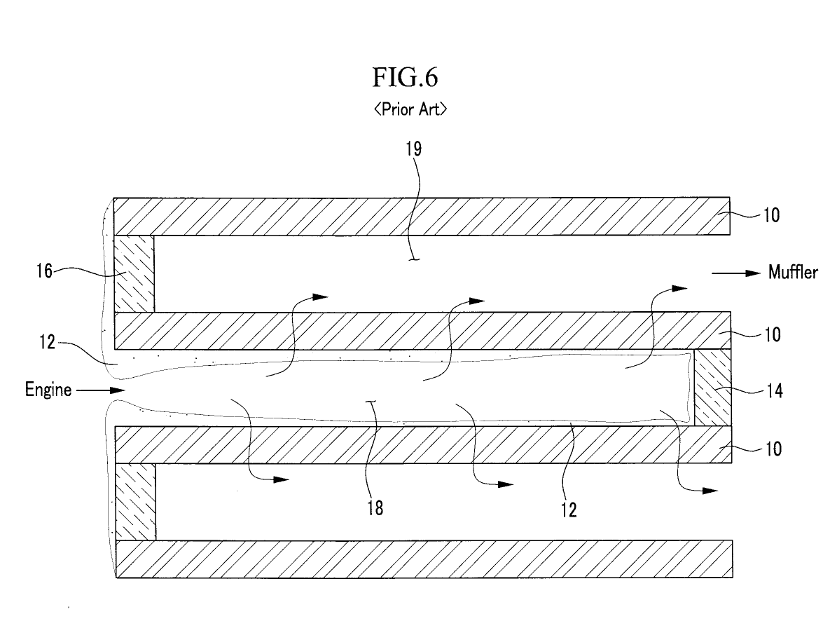

FIG. 5A to FIG. 5G are cross-sectional side views showing a sequential manufacturing method of an exhaust gas purification device according to an exemplary embodiment of the present invention.

Referring to FIG. 5A, a plurality of channels through which exhaust gas passes are formed in a filter body 500 from one end to the other end, and the channels include a first channel 505a, a second channel 505b, and a third channel 505c.

A mask 510 is disposed to face the front surface of the filter body 500, and a first mask hole 510a and a second mask hole 510b are formed in the mask 510. The first mask hole 510a corresponds to the first channel 505a, and the second mask hole 510b corresponds to the third channel 505c.

In addition, a pushing member 520 is disposed at the opposite side of the filter body 500 with a predetermined gap from the mask 510, and the pushing member 520 is connected to a driving portion 525. Further, a plugging material 515 is disposed between the pushing member 520 and the mask 510.

Referring to FIG. 5B, the driving portion 525 compresses the pushing member 520 against the mask 510 such that the plugging material 515 is squeezed through the first mask hole 510a and the second mask hole 510b to be injected into the inlets of the first channel 505a and the third channel 505c.

Referring to FIG. 5C, a first plug 530a and a second plug 530b are respectively formed in the inlet portions of the first channel 505a and the third channel 505c. Further, a plug is formed in the outlet portion of the second channel 505b, and a detailed description thereof will be omitted.

Referring to FIG. 5D, the first channel 505a, the second channel 505b, and the third channel 505c are formed in the filter body 500 from the front surface to the rear surface, the first plug 530a is disposed at the front inlet of the first channel 505a, and the second plug 530b is disposed at the front inlet of the third channel 505c.

The mask 510 is then disposed to face the front surface of the filter body 500, and the first mask hole 510a that corresponds to the first channel 505a and the second mask hole 510b that corresponds to the third channel 505c are formed in the mask 510.

The pushing member 520 is disposed at the opposite side of the filter body 500 with a gap from the mask 510, and the pushing member 520 is connected to the driving portion 525. Then, a high polymer organic compound 540 is disposed between the pushing member 520 and the mask 510.

Referring to FIG. 5E, the driving portion 525 compresses the pushing member 520 against the one surface of the mask 510. Then, the high polymer organic compound 540 is squeezed through the first mask hole 510a of the mask 510 to be injected into the first channel 505a and to be injected into the third channel 505c through the second mask hole 510b.

Here, the high polymer organic compound 540 pushes the first plug 530a that is formed at the first channel 505a forward and pushes the second plug 530b that is formed at the third channel 505c forward.

Referring to FIG. 5F, the first plug 530a and the second plug 530b are pushed by the high polymer organic compound 540 that is squeezed therein to be moved as much as a predetermined length from the front surface toward the rear surface of the filter body 500.

As described above, the first plug 530a and the second plug 530b are formed by the plugging material 515, and they are not fixed in the filter body 500 such that they can be pushed to be moved by the high polymer organic compound 540.

Referring to FIG. 5G, the first and second plugs 530a and 530b are inserted in a predetermined distance d1, and a heater 550 is disposed adjacently to the front surface of the filter body 500 to be operated so as to remove the high polymer organic compound 540. The heater 550 melts the high polymer organic compound 540, and the first and second plugs 530a and 530b are further solidified by the heat to be fixed inside the channel of the filter body 500.

As described above, the method for forming the first and second plugs 530a and 530b in the filter body 500 includes a first injection step in which the plugging material 515 is injected into the inlet of at least one channel 505a, 505b, and 505c that are formed in the filter body 500, and a second injection step in which the high polymer organic compound 540 is further injected into the inlet of the channels 505a, 505b, and 505c to push in the plugging material 515 to the outlet side thereof by a predetermined distance.

Further, the method includes a removing step in which the injected high polymer organic compound 540 is melted by heat energy of the heater 550 to be easily eliminated.

For convenience in explanation and accurate definition in the appended claims, the terms “front”, “rear”, and “inside” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An exhaust gas purification apparatus that includes a filter in which a plurality of channels are formed therein such that exhaust gas exhausted from a combustion chamber can pass therethrough to trap pollutants included in the exhaust gas, comprising:
a first plug that plugs an inlet of at least one channel; and
a second plug that plugs an outlet of at least one channel,
wherein the first plug is inserted in a predetermined distance from the inlet of the at least one channel toward an outlet direction thereof at a front surface of the at least one channel.

2. The exhaust gas purification apparatus of claim 1, wherein the filter is applied to a diesel particulate filter (DPF).

3. The exhaust gas purification apparatus of claim 1, wherein the at least one channel including the first plug and the at least one channel including the second plug are alternatively disposed.

4. The exhaust gas purification apparatus of claim 1, wherein the filter is applied to a catalyzed particulate filter (CPF) in which an oxidation catalyst or a wash coat is coated therein.

5. The exhaust gas purification apparatus of claim 1, wherein the filter is mounted in a diesel oxidation catalyst (DOC) or a diesel particulate filter (DPF).

6. The exhaust gas purification apparatus of claim 2, wherein a selective catalytic reduction apparatus is mounted at a downstream side of the filter.

7. The exhaust gas purification apparatus of claim 1, wherein a temperature of the filter is increased toward a rear end portion from a frond end portion of the filter in a regeneration mode for eliminating trapped soot in the filter, and the first plug is disposed at a position having a predetermined temperature such that the trapped soot can be eliminated.

8. The exhaust gas purification apparatus of claim 7, wherein the predetermined distance of the first plug is more than approximately one inch.

9. The exhaust gas purification apparatus of claim 1, wherein the filter is extended as much as the predetermined distance of the first plug.

10. A method for forming a plug that alternatively closes an inlet or outlet of channels that are formed in a flowing direction of exhaust gas, comprising:
a first injection step of injecting a plugging material into the channels of a filter body so as to form the plug closing the inlet or outlet of the channels;
a second injection step of moving the plug toward an outlet direction of the channels with at least a predetermined length by injecting a high polymer organic compound into the channel; and
a removing step of removing the injected high polymer organic compound except the plug.

11. The method for forming a plug of claim 10, further comprising:
facing one side surface of a mask toward a front surface of the filter body wherein the mask includes a mask hole formed corresponding to the channels;
facing a pushing member against the mask with a predetermined gap;
disposing a plugging material between the pushing member and the mask; and
actuating a driving portion to push the pushing member toward the mask such that the plugging material is injected into the channels through the mask holes.

12. The method for forming a plug of claim 10, further comprising:
facing one side surface of a mask toward a front surface of the filter body wherein the mask includes a mask hole formed corresponding to the channels;
facing a pushing member against the mask with a predetermined gap;
actuating a driving portion to insert the pushing member into inlets of the channels with a predetermined amount;
disposing a high polymer organic compound between the pushing member and the mask; and
actuating the driving portion to push the pushing member toward the mask such that the high polymer organic compound is injected into the channels through the mask holes so as to move the plugging material forwards as much as a predetermined length.

13. The method for forming a plug of claim 10, wherein in the removing step of the high polymer organic compound, the high polymer organic compound is removed at a higher temperature than a predetermined temperature.

14. A device for manufacturing an exhaust gas purification device for forming a plug in a filter body in which a plurality of channels are formed in a flowing direction of exhaust gas, comprising:
a mask of which one side surface thereof faces a front surface of the filter body wherein the mask includes a mask hole formed corresponding to the channels;
a pushing member that faces the mask with a predetermined gap;
a plugging material that is disposed between the pushing member and the mask; and
a driving portion that moves the pushing member toward the mask so as to inject the plugging material into the channels through the mask holes with a predetermined amount,
wherein a high polymer organic compound is injected into the channels through the mask holes so as to push the inserted plugging material by as much as a predetermined distance, and the injected high polymer organic compound is removed except the plugging material.

15. The device for manufacturing an exhaust gas purification device of claim 14, further comprising a heating unit that removes the high polymer organic compound with heat from the channels.

16. The device for manufacturing an exhaust gas purification device of claim 14, wherein the driving portion moves the pushing member forwards, and the high polymer organic compound is injected into the inlets of the channels through the mask holes to insert the plugging material in an outlet direction of the filter body by as much as a predetermined length.
